(19) United States
(12) Patent Application Publication
(10) Pub. No.: US 2006/0293485 A1
(43) Pub. Date: Dec. 28, 2006

(54) Aqueous multicomponent system, process for its preparation, and its use

(75) Inventors: Heinz-Peter Rink, Munster (DE); Susanne Piontek, Munster (DE); Christine Alpert, Munster (DE); Lutz-Werner Gross, Haltern am See (DE); Andreas Jansen, Munster (DE)

Correspondence Address: BASF CORPORATION, 1609 BIDDLE AVENUE, WYANDOTTE, MI, 48192, US

(73) Assignee: BASF COATINGS AG,, Munster (DE)

(21) Appl. No.: 11/179,193

(22) Filed: Jul. 12, 2005

(30) Foreign Application Priority Data
Jul. 17, 2004 (DE) 10 2004 034 715.8

(51) Int. Cl. C08G 18/00

(52) U.S. Cl. 528/44

(57) ABSTRACT

An aqueous multicomponent system comprising (I) at least one aqueous component comprising dissolved and/or dispersed therein at least one polyurethane-based graft copolymer (P) containing isocyanate-reactive functional groups and preparable by graft copolymerizing at least one polyurethane (P′) selected from the group consisting of hydrophobic or hydrophilic polyurethanes containing on average at least one functional group selected from the group consisting of thiocarbamate groups, thiol groups and sulfide groups with at least one olefinically unsaturated monomer, or alternatively (II) at least one liquid organic component comprising at least one water soluble and/or dispersible, polyurethane-based graft copolymer (P) and (III) at least one aqueous component, and (IV) at least one liquid organic component comprising or consisting of at least one polyisocyanate, processes for preparing it, and its use.

The present invention relates to a new aqueous multicomponent system. The present invention also relates to a new process for preparing an aqueous multicomponent system. The present invention further relates to the use of the new aqueous multicomponent system and of the aqueous multicomponent system prepared by the new process for preparing coating materials, adhesives and sealants for producing coatings, adhesive layers and seals.

Aqueous multicomponent systems comprising
at least one aqueous component containing at least one dissolved and/or dispersed, optionally (meth)acrylated polyurethane having isocyanate-reactive functional groups, and
at least one liquid organic component comprising or consisting of at least one polyisocyanate
   are known for example from European patent application EP 0 952 170 A1 or German patent application DE 43 26 670 A1.

Aqueous multicomponent systems which comprise
at least one liquid organic component containing at least one water soluble and/or dispersible polyurethane having isocyanate-reactive functional groups,
at least one liquid organic component comprising or consisting of at least one polyisocyanate, and
at least one water containing component
   are known from German patent applications DE 44 21 823 A1, DE 195 42 626 A1 or DE 198 55 125 A1 or from international patent application WO 97/14731 A1.

The known aqueous multicomponent systems serve primarily for preparing coating materials, such as surfacers, aqueous basecoat materials and topcoat materials, such as solid-color topcoat materials and clear coat materials, especially solid-color topcoat materials and clear coat materials. The known coating materials, however, still always have an undesirably high level of organic solvents. The solid-color topcoats and clear coats produced using them also require further improvement in their solvent resistance and chemical resistance.

Aqueous solutions and/or dispersions of polyurethane-based graft copolymers containing isocyanate-reactive functional groups and preparable by graft copolymerizing at least one polyurethane selected from the group consisting of hydrophobic or hydrophilic polyurethanes containing on average at least one functional group selected from the group consisting of thiocarbamate groups, thiol groups and sulfide groups with at least one olefinically unsaturated monomer are known from German patent applications DE 100 17 653 A1, DE 100 53 890 A1 and DE 102 23 652 A1. The aqueous solutions and/or dispersions serve for preparing coating materials, adhesives and sealants, especially aqueous basecoat materials, which are curable thermally or both thermally and with actinic radiation (dual cure). These materials, however, are what are called one-component systems, in which the binders can be present alongside the crosslinking agents, such as blocked polyisocyanates, since their complementary reactive functional groups react with one another only at well above room temperature. It is not known whether the known solutions and/or dispersions of the polyurethane-based graft copolymers are suitable for preparing multicomponent systems. In particular the German patent applications do not reveal whether such multicomponent systems are suitable for preparing aqueous topcoat materials, such as solid-color topcoat materials and clear coat materials, which have a low organic solvent content or whether they produce topcoats, such as solid-color topcoats and clear coats, which have high chemical resistance and solvent resistance.

It is an object of the present invention to provide a new aqueous multicomponent system of the type specified at the outset that no longer has the drawbacks of the prior art but instead has a lower organic solvent content than the coating materials, adhesives and sealants prepared from the known aqueous multicomponent systems.

The new coating materials, adhesives and sealants ought to produce coatings, especially topcoats such as clear coats and solid-color topcoats, and also adhesive layers and seals which have better chemical resistance and solvent resistance than those produced from the known coating materials, adhesives and sealants.

The invention accordingly provides the new aqueous multicomponent system which comprises
(I) at least one aqueous component comprising dissolved and/or dispersed therein at least one polyurethane-based graft copolymer (P) containing isocyanate-reactive functional groups and preparable by graft copolymerizing at least one polyurethane (P′) selected from the group consisting of hydrophobic or hydrophilic polyurethanes containing on average at least one functional group selected from the group consisting of thiocarbamate groups, thiol groups and sulfide groups with at least one olefinically unsaturated monomer,
or alternatively
(II) at least one liquid organic component comprising at least one water soluble and/or dispersible, polyurethane-based graft copolymer (P) and
(III) at least one aqueous component,
   and
(IV) at least one liquid organic component comprising or consisting of at least one polyisocyanate
   and is referred to below as “multicomponent system of the invention”.

The invention also provides the new process for preparing the multicomponent system of the invention, which involves preparing components (I) or (II) and (III) and also (IV) by mixing their respective constituents and homogenizing the resulting mixtures, then storing components (I) or (II) and (III) separately from component (IV) until the multicomponent system of the invention is used, and which is referred to below as “process of the invention”.

The invention additionally provides for the new use of the multicomponent system of the invention and of the multicomponent system prepared by the process of the invention for preparing new coating materials, adhesives and sealants which are used for producing new coatings, adhesive layers and seals, this being referred to below as “use in accordance with the invention”.

Further subject matter of the invention will emerge from the description.

In the light of the prior art it was surprising and unforeseeable for the skilled worker that the object on which the present invention was based could be achieved by means of the multicomponent system of the invention, the process of the invention, and use in accordance with the invention.

In particular it was surprising that the multicomponent system of the invention and the multicomponent system of the invention prepared by means of the process of the invention had a lower organic solvent content than the known multicomponent systems.

It was also surprising that use in accordance with the invention resulted in coatings, especially topcoats such as clear coats and solid-color topcoats, and also adhesive layers and seals, which exhibited better chemical resistance and solvent resistance than those produced from the known coating materials, adhesives and sealants.

The multicomponent system of the invention comprises as the essential constituents at least components (I) and (IV) or alternatively (II), (III) and (IV).

In addition it may comprise at least one further component (V), such as, for example, the finely divided solid component, described in detail in German patent application DE 199 04 317 A1, page 3 line 6 to page 8 line 10, which comprises or consists of at least one, especially one, optionally water soluble or water dispersible, oligomeric and/or polymeric binder.

Components (I) and (IV) or (II), (III) and (IV) and also the further components present where appropriate may also be provided in the form of a mixer system or modular system (cf., for example, German patent application DE 199 04 330 A1) comprising, for example, two or more different pigmented components (I) or (II) as base colors, so that from a comparatively small number of base colors it is possible with the aid of color mixing formulas to provide coating materials which produce coatings having a very wide variety of shades and optical effects.

The inventively essential constituent of the multicomponent system of the invention is at least one, especially one, polyurethane-based graft copolymer (P).

It is preparable by graft copolymerizing at least one polyurethane (P′) selected from the group consisting of hydrophobic or hydrophilic polyurethanes containing on average at least one functional group selected from the group consisting of thiocarbamate groups, thiol groups and sulfide groups with at least one olefinically unsaturated monomer.

Hydrophobic or hydrophilic, especially hydrophilic, polyurethanes (P′) containing on average at least one thiol group are known from German patent application DE 100 17 653, page 3 paragraph [0023] to page 7 paragraph [0078], and page 12 paragraphs [0129] to [0131].

Hydrophobic or hydrophilic, especially hydrophilic, polyurethanes (P′) containing on average at least one sulfide group are known from German patent application DE 100 53 890 A1, column 3 paragraph [0016], column 4 paragraph [0028] to column 12 paragraph [0096], and column 22 paragraph [0151] to column 23 paragraph [0155].

Hydrophobic or hydrophilic, especially hydrophilic, polyurethanes (P′) containing on average at least one thiocarbamate group are known from German patent application DE 102 23 652 A1, column 3 paragraph [0019] to column 10 paragraph [0074] and also column 18 paragraph [0118] to column 19 paragraph [0120].

To prepare the graft copolymers (P) the polyurethanes (P′) are grafted in an aqueous solution or dispersion, or in organic solution, with at least one olefinically unsaturated monomer.

Graft copolymerization in aqueous solution or dispersion produces a primary dispersion of the graft copolymer (P), which can be used directly as component (I) or as component (III) or for preparation thereof.

Graft copolymerization in organic solution produces an organic solution or dispersion of the graft copolymer (P), which can be used directly as component (II) or to prepare it. The organic solution or dispersion of the graft copolymer (P) may alternatively be dispersed in water or an aqueous medium, giving a secondary dispersion of the graft copolymer (P) which can be used as component (I) or as component (III) or for preparation thereof.

Regarding the details, reference is made to German patent applications
DE 100 17 653 A1 page 7 paragraphs [0080] to [0085] in conjunction with page 12 paragraph [0133] to page 13 paragraph [0135],
DE 100 53 890 A1 column 12 paragraph [0098] to column 13 paragraph [0103] in conjunction with column 23 paragraphs [0156] and [0157], and
DE 102 23 652 A1 column 10 paragraph [0075] to column 11 paragraph [0081] in conjunction with column 19 paragraphs [0121] to [0124].

Examples of suitable olefinically unsaturated monomers for the graft copolymerization are described in detail in German patent applications
DE 100 17 653 A1 page 7 paragraph [0086] to page 9 paragraph [0096] in conjunction with page 12 paragraph [0133] to page 13 paragraph [0135],
DE 100 53 890 A1 column 13 paragraph [0104] to column 16 paragraph [0114] in conjunction with column 23 paragraphs [0156] and [0157], and
DE 102 23 652 A1 column 11 paragraph [0082] to column 14 paragraph [0092] in conjunction with column 19 paragraphs [0121] to [0124].

Processes for the graft copolymerization emerge in detail from German patent applications
DE 100 17 653 A1 page 9 paragraph [0097] to page 10 paragraph [0105] in conjunction with page 12 paragraph [0133] to page 13 paragraph [0135],
DE 100 53 890 A1 column 16 paragraph [0115] to column 18 paragraph [0123] in conjunction with column 23 paragraphs [0156] and [0157], and
DE 102 23 652 A1 column 14 paragraph [0093] to column 16 paragraph [0101] in conjunction with column 19 paragraphs [0121] to [0124].

The graft copolymers (P) are preferably in component (I). The amount of graft copolymers (P) in component (I) may vary very widely. Preferably the amount is from 5 to 60% by weight, more preferably from 10 to 55% by weight and in particular from 10 to 50% by weight, based in each case on the solids of component (I).

Here and below, “solids” refers to the sum of the constituents of the multicomponent system of the invention that constitute the solids of the coatings, adhesive layers and seals produced from it.

Components (I), (II) and (III), but especially component (I), may comprise at least one further constituent selected from the group consisting of pigments, non-polyisocyanate crosslinking agents containing reactive functional groups which react—with themselves or with their complementary reactive functional groups—only at relatively high temperatures, binders other than the polyurethane-based graft copolymers (P), compounds containing at least one reactive functional group having at least one bond which can be activated with actinic radiation, and coatings additives.

By actinic radiation is meant, here and below, electromagnetic radiation, such as IR radiation, near infrared (NIR) radiation, visible light, UV radiation, x-rays and gamma radiation, especially UV radiation, and corpuscular radiation, such as electron beams, beta radiation, alpha radiation, proton beams or neutron beams, especially electron beams.

Examples of suitable pigments and preferred amounts in which they can be used are known from German patent application DE 101 29 970 A1, page 16 paragraph [0105] to page 12 paragraph [0121].

Examples of suitable crosslinking agents other than the polyisocyanates of component (IV) are known from German patent application DE 198 55 125 A1, page 13 lines 7 to 61.

Examples of suitable binders other than the graft copolymers (P) are known from German patent applications DE 44 21 823 A1, DE 195 42 626 A1 or DE 198 55 125 A1 or international patent application WO 97/14731 A1.

Examples of suitable compounds containing at least one reactive functional group having at least one bond which can be activated with actinic radiation, and the amounts in which they are preferably employed, are known from German patent application DE 101 29 970 A1, page 11 paragraphs [0101] to [0103].

Examples of suitable coatings additives are likewise known from German patent application DE 101 29 970 A1, page 12 paragraph [0123].

The multicomponent system of the invention comprises the liquid organic component (IV). Preferably the component (IV) is entirely free from water, except for the traces introduced, for example, by other constituents of component (IV) or in the course of handling.

Component (IV) comprises or consists of at least one polyisocyanate. If it is a solid polyisocyanate, component (IV) is rendered liquid by adding organic, preferably water miscible, solvents which are essentially or entirely inert toward polyisocyanates.

The water free, liquid components (II) comprise at least one, especially one, polyisocyanate. The polyisocyanates may also contain reactive functional groups which can be activated with actinic radiation and so are able to participate in actinic radiation curing. Such polyisocyanates are referred to below as “dual cure polyisocyanates”.

Examples of suitable polyisocyanates for use in component (IV) are known from German patent applications
DE 44 21 823 A1, page 12 lines 4 to 35; or
DE 199 14 899 A1, page 18 line 40 to page 19 line 9 and page 19 line 67 to page 20 line 12.

Examples of suitable dual cure polyisocyanates for use in components (IV) are known from German patent application DE 101 29 970 A1, page 2 paragraph [0008], with reference to European patent application EP 0 928 800, and also page 6 para. [0042] to page 11 para. [0099].

Component (IV) may comprise the additives described above provided they are essentially or entirely inert toward polyisocyanates under the conditions in which component (IV) is stored. It is preferred to use additives which act to lower surface tension. Compounds of this kind are described for example in European patent application EP 0 915 116 A1, column 6 lines 14 to 30.

The multicomponent system of the invention is prepared preferably by the process of the invention.

The process of the invention comprises preparing components (I) or (II) and (III) and also (IV) by mixing their respective constituents and homogenizing the resulting mixtures, then storing components (I) or (II) and (III) separately from component (IV) until the multicomponent system of the invention is used.

In terms of method the preparation of components (I) to (IV) has no special features but instead takes place by mixing and homogenizing the above described constituents using conventional mixing methods and apparatus such as stirred tanks, agitator mills, extruders, kneading apparatus, Ultraturrax, inline dissolvers, static mixers, toothed-wheel dispersers, pressure release nozzles and/or microfluidizers, in the absence of actinic radiation where appropriate, i.e., where the resultant components (I) to (IV) include constituents which can be activated by actinic radiation.

The multicomponent systems of the invention serve for preparing coating materials and also adhesives and sealants. Preferably the multicomponent systems of the invention serve for preparing coating materials, more preferably surfacers, aqueous basecoat materials and topcoat materials, with particular preference topcoat materials, especially solid-color topcoat materials and clear coat materials. The coating materials, adhesives and sealants, particularly the coating materials, are preferably in the form of oil-in-water dispersions.

To prepare the coating materials, adhesives and sealants of the invention, especially the coating materials of the invention, components (I) and (IV) or components (II), (III) and (IV) are mixed with one another prior to their use as intended. The amounts of components (I) and (IV) or (II), (III) and (IV) are preferably chosen so as to result in an equivalent ratio of isocyanate groups to isocyanate-reactive groups of from 2:1 to 1:2, preferably from 1.5:1 to 1:1.5 and in particular from 1.2:1 to 1:1.2.

The preparation of the coating materials of the invention has no special features in terms of method; rather it is possible to use the apparatus and methods described above.

The coating materials of the invention preferably have a solids content, i.e., an amount of constituents which constitute the coatings produced from the mixtures, of from 10 to 90%, more preferably from 20 to 80% and in particular from 30 to 70% by weight, based in each case on one coating material.

The coating materials of the invention, based on the total amount of the water they contain and the organic solvents they contain, contain preferably more than 50% by weight, more preferably at least 55% by weight and in particular at least 60% by weight of water, so that the solubility properties are essentially characterized by the water.

The coating materials of the invention have a pot life or processing life of several hours. This considerably facilitates operational planning on the part of users.

The coating materials of the invention are curable thermally. This means that they can be cured at room temperature or at higher temperatures. This can be done using the conventional apparatus, such as forced air ovens, hot air blowers or radiant heaters, especially NIR or IR rays or microwave sources.

The coating materials of the invention may also be curable both thermally and with actinic radiation, this being referred to by those in the art as dual cure. For curing with actinic radiation it is possible to use the conventional apparatus, such as UV lamps or electron beam sources (cf. also German patent application DE 101 29 970 A1, page 13 para. [0132]).

Application of the coating materials of the invention has no special features in terms of method but may instead take place by any customary application method, such as spraying, knifecoating, brushing, flow coating, dipping, trickling or rolling, for example. Where appropriate it is advisable to operate in the absence of actinic radiation in order to prevent premature crosslinking of the coating materials of the invention.

The coating materials, adhesives and sealants of the invention are outstandingly suitable for the coating, adhesive bonding and sealing of substrates of any kind, especially bodies of means of transport, including means of transport operated by engine power and/or muscle power, such as automobiles, utility vehicles, buses, cycles, rail vehicles, watercraft and aircraft, and parts thereof, buildings, doors, windows, furniture and parts thereof, small industrial parts, mechanical, optical and electronic components, coils, containers, packaging and hollow glassware, and articles of everyday use.

The resulting coatings in particular have an outstanding overall appearance, high gloss, high condensation resistance, outstanding chemical resistance and outstanding solvent resistance.

### EXAMPLE

The Preparation of a Pigmented Two-Component System and of a Two-Component Solid-Color Topcoat Material and Production of a Solid-Color Topcoat Therefrom

A suitably sized reaction vessel equipped with stirrer, column with reflux condenser, nitrogen inlet tube, water separator and heating, was charged with 127.74 parts by weight of isophthalic acid, 592.85 parts by weight of hexahydrophthalic anhydride, 449.45 parts by weight of adipic acid, 240.41 parts by weight of neopentyl glycol, 628.48 parts by weight of neopentyl glycol hydroxypivalate and 665.41 parts by weight of cyclohexane-1,4-dimethanol. Under a nitrogen atmosphere the reaction mixture was heated in steps of 10° C./h from 140° C. to 230° C. and at 230° C. was esterified to an acid number of 5.4 mg KOH/g. Xylene was used as azeotrope former. When the acid number had been reached the resultant polyester was adjusted with methyl isobutyl ketone to a solids of 90% by weight.

A reaction vessel suitable for reaction of isocyanates was charged with 925.7 parts by weight (corresponding to 838.7 parts by weight of solids) of polyester, 312.6 parts by weight of thiodiethanol, 1.2 parts by weight of dibutyltin dilaurate, 1.398 parts by weight of methyl isobutyl ketone and 949.5 parts by weight of isophorone diisocyanate, after which the resulting mixture was heated to 105° C. The temperature was maintained until the free isocyanate group content was constant. Subsequently 244.9 parts by weight of trimethylolpropane were added. The resulting mixture was heated further until the free isocyanate group content had dropped below the detection limit.

530.47 parts by weight (corresponding to 383 parts by weight of solids) of the resulting polyurethane (P′) were heated to 105° C. in a suitable reaction vessel equipped with stirrer, reflux condenser, two feed vessels and heating. From the first feed vessel a monomer mixture consisting of 29.87 parts by weight of acrylic acid, 188.4 parts by weight of hydroxypropyl methacrylate, 30.64 parts by weight of n-butyl acrylate, 57.45 parts by weight of t-butylcyclohexyl acrylate, 38.29 parts by weight of styrene and 38.29 parts by weight of trimethylcyclohexyl methacrylate was added dropwise over three hours. 11.49 parts by weight of t-butyl peroxy-2-ethylhexanoate were dissolved in 96.4 parts by weight of methyl isobutyl ketone. The resulting solution was added dropwise from the second feed vessel over 3.5 hours, beginning at the same time. Following the addition the reaction mixture was postpolymerized at 105° C. for 2.5 hours more. It was then cooled to 90° C. and neutralized with 32.22 parts by weight of dimethylethanolamine for 15 minutes. After a further 30 minutes 1094.1 parts by weight of water were metered in over the course of one hour. Finally the organic solvent was removed by vacuum distillation from the resulting dispersion of the graft copolymer (P). The dispersion had a solids content of 40% by weight. The number-average molecular weight of the graft copolymer (P) was 29 653 daltons, the mass-average molecular weight 5794 (determined by gel permeation chromatography with polystyrene as internal standard).

To prepare component (I) of the two-component solid-color topcoat material, 55 parts by weight of the dispersion were mixed in a dissolver, at a speed of 2000/min, with 1.28 parts by weight of a commercial wetting agent (Surfynol 104 as a 52% solution in butyl glycol), 0.16 part by weight of Borchigel® PW 25 (commercial thickener from Borchers), 1.07 parts by weight of Baysilone® 3469 (commercial flow additive from Borchers), 8.22 parts by weight of Borchigen® SN95 (commercial dispersing additive from Borchers) and 34.27 parts by weight of titanium rutile R 706. The resulting mixture was stirred in the dissolver for 10 minutes more and then ground in a laboratory mill for two hours with SAZ beads until the millbase had a particle size of 3 to 5 μm.

Component (IV) was prepared by mixing 80 parts by weight of Bayhydur® VPLS 2319 (hydrophilic polyisocyanate based on HDI trimer from Bayer Aktiengesellschaft) and 20 parts by weight of Butoxyl.

30 parts by weight of component (IV) were mixed with 100 parts by weight of component (I) by slow addition with stirring at a speed of 800/min. The processing viscosity for pneumatic spray application of the resulting solid-color topcoat material was set by adding 28 parts by weight of water.

The solid-color topcoat was applied to steel panels which had been coated with an electrocoat and an antistonechip primer. The solid-color topcoat films were dried at room temperature for 30 minutes and at 60° C. for 60 minutes. After forced curing at 80° C. for 16 hours, solid-color topcoats with a gloss of 80 units at 20° C. were obtained. They withstood more than 200 double rubs with a cotton pad soaked in methyl ethyl ketone. They also showed no bubbles or swelling at all following exposure in the constant climate test. Adhesion to the antistonechip primer was outstanding.

The table gives an overview of the outstanding results of the chemical stability tests.

TABLE
Chemical stability of the solid-color topcoats

| Test | Surface changes: | | |
|---|---|---|---|
| (VDA* standard 621-412) | Immediately | After 1 h | After 24 h |
| Diesel 1 h, 23° C., filter | 0 | 0 | 0 |
| Isopropanol 1 h, 23° C., filter | 0 | 0 | 0 |
| Engine oil 16 h, 23° C., filter | 0 | 0 | 0 |
| NaOH 5%, 1 h, 23° C., applied | 0 | 0 | 0 |
| dropwise | | | |
| Screen wash 1 h, 23° C., filter | 0 | 0 | 0 |
| Sulfuric acid 10%, 1 h, 23° C., | 0 | 0 | 0 |
| applied dropwise | | | |
| Super-grade gasoline 10 min, | 0 | 0 | 0 |
| 23° C., filter/ | | | |
| Low-temperature cleaner, 24 | 0 | 0 | 0 |
| hours, 23° C., | | | |
| applied dropwise | | | |
| Xylene 1 h, 23° C., filter | 0 | 0 | 0 |
| Silicone remover, 1 h, 23° C., | 0 | 0 | 0 |
| applied dropwise | | | |

*VDA - German Automakers' Association

1. An aqueous multicomponent system comprising at least one of (I) or (II) and (III), wherein
(I) is at least one aqueous component comprising dissolved and/or dispersed therein at least one polyurethane-based graft copolymer (P) containing isocyanate-reactive functional groups and prepared by graft copolymerizing at least one polyurethane (P′) selected from the group consisting of hydrophobic or hydrophilic polyurethanes containing on average at least one functional group selected from the group consisting of thiocarbamate groups, thiol groups and sulfide groups with at least one olefinically unsaturated monomer,
(II) is at least one organic component comprising at least one water soluble and/or dispersible, polyurethane-based graft copolymer (P) and
(III) is at least one aqueous component,
and the milticomponent system further comprises
(IV) at least one component comprising at least one polyisocyanate.

2. The aqueous multicomponent system as claimed in claim 1, further comprising at least one-constituent-selected from the group consisting of pigments, non-polyisocyanate crosslinking agents containing reactive functional groups which react—with themselves or with their complementary reactive functional groups—only at relatively high temperatures, binders other than the polyurethane-based graft copolymers (P), compounds containing at least one reactive functional group having at least one bond which can be activated with actinic radiation, and coatings additives.

3. The aqueous multicomponent system as claimed in claim 1 wherein component (III) comprises at least one polyurethane-based graft copolymer (P).

4. The aqueous multicomponent system as claimed in claim 1, wherein component (IV) comprises at least one additive which acts to lower surface tension.

5. The aqueous multicomponent system as claimed in claim 1, wherein the aqueous component (I) and/or component (II) contain or contains reactive functional groups having at least one bond which can be activated with actinic radiation.

6. (canceled)

7. A process for preparing the aqueous multicomponent system as claimed in claim 1, which comprises preparing components (I) or (II) and (III) and also (IV) by mixing their respective constituents and homogenizing the resulting mixtures, then storing components (I) or (II) and (III) separately from component (IV) until the multicomponent system of the invention is used.

8. A composition comprising the aqueous multicomponent system as claimed in claim 1 selected from the group consisting of coating materials, adhesives and sealants.

9. (canceled)

10. A substrate comprising thereon, the composition of claim 8, where said substrate is selected from the group consisting of, bodies of means of transport or parts thereof, buildings, furniture, windows and doors and parts thereof, small industrial parts, coils, containers, packaging, white goods, films, optical components, electrical components, mechanical components or glassware and combinations thereof.
